(19) United States
(12) Patent Application Publication
(10) Pub. No.: US 2017/0210646 A1
(43) Pub. Date: Jul. 27, 2017

(54) ANIMAL FARMING WASTEWATER TREATMENT

(71) Applicant: TEVET WATER TECHNOLOGIES LTD., Givat Shmuel (IL)

(72) Inventors: Yehoyada ZIDON, Jerusalem (IL); Guri SHAANAN, Qiryat Uno (IL); Bnaya ZIDON, Givaat-Shmuel (IL)

(21) Appl. No.: 15/515,226

(22) PCT Filed: Sep. 20, 2015
(86) PCT No.: PCT/IL2015/050948

§ 371 Date: Mar. 29, 2017

(30) Foreign Application Priority Data
Sep. 29, 2014 (IL) 234889

(51) Int. Cl. C02F 1/56; C02F 3/30; C02F 11/12

(52) U.S. Cl. CPC C02F 1/56; C02F 11/123; C02F 3/305; C02F 2101/105

(57) ABSTRACT

A process for treating wastewater from livestock industry, comprising subsequently admixing two different types of nitrogen-containing cationic polymers into the treated livestock industrial wastewater, wherein said polymers comprise polydiallyldimethylammonium chloride (PDAC) and cationic polyacrylamide (CPA).

### FIELD OF THE INVENTION

The present invention relates to process for treating waste water from cowsheds and pig sties, which process substantially reduces COD (Chemical Oxygen Demand), phosphorus and nitrogen in the treated water.

### BACKGROUND OF THE INVENTION

The livestock industry produces a large volume of wastewater which contains a number of environmentally and hygienically detrimental chemical and biological factors, including high nitrate and phosphorus contents, synthetic antibiotics and hormones, spores and eggs of parasites, as well as pathogenic bacteria. Application of insufficiently processed animal farm wastewater can cause severe environmental contamination, including soil and water pollution. Even a low-level seepage may be dangerous; therefore, many techniques have been employed in order to reduce the harmful effects of the animal wastewater, comprising mixing water with straws, composting, ensiling, containing in a slurry lagoon, eventually diluting, or treating with disinfectants and other chemicals, whereby reducing the levels of solids, oxygen demand, phosphorus, nitrates or nitrites, heavy metals, worm eggs, protozoa spores, human bacterial pathogens, etc. There is still a need of efficient new methods for treating wastewater from animal farms. It is therefore an object of this invention to provide a process for treating livestock industry wastewater. WO 2014/071240 describes a composition for treating recreational water via use of a phosphate removing substance and a polymer flocculant sealed in a soluble pouch, wherein the flocculant may be selected from acrylamide copolymers. It is an object of this invention to provide a process for treating livestock industry wastewater by employing cationic polyacrylamide based flocculants.

It is another object of this invention to provide a process for treating animal farm wastewater, particularly wastewater from cattle farms and pigs farms.

It is still another object of this invention to provide a process for treating animal farm wastewater, including reducing substantially the chemical oxygen demand in the treated water via physico-chemical treatment.

It is a still further object of this invention to provide a process for treating animal farm wastewater, including reducing the high organic contents in the treated water.

It is also an object of this invention to provide an environmentally sensitive and economically effective process for treating animal farm wastewater, including reducing the solid contents in the treated water by employing a flocculant.

Other objects and advantages of present invention will appear as description proceeds.

### SUMMARY OF THE INVENTION

The present invention provides a process for treating wastewater from livestock industry, comprising a step of subsequently admixing at least two nitrogen-containing cationic polymers into the treated livestock industrial wastewater, wherein said nitrogen-containing polymers preferably comprise polydiallyldimethylammonium chloride (PDAC) and cationic polyacrylamide (CPA). Said PDAC is preferably added to said wastewater up to a concentration of from 50 ppm to 500 ppm (on 100% basis) and said CPA is subsequently added to said wastewater up to a concentration of from 5 ppm to 50 ppm (on 100% basis). The process of the invention usually comprises steps of i) collecting waste water from animal farming activities comprising high contents of organic matter, solids, nitrogen, and phosphorus; ii) contacting said collected waste water with PDAC and stirring; iii) contacting said collected waste water containing PDAC with CPA and stirring; iv) allowing the mixture obtained in step iii to stand without stirring, whereby separating an upper liquid phase with a reduced amount of solids and a lower phase with an increased amount of solids; v) drawing said lower phase (dilute sludge) from step iv to a sludge thickener and/or a belt press and filtering it, thereby obtaining a filtrate and a concentrated sludge having a solid content of 10% or more; the filtrate may be combined with the waste water of step i or step iii, or may be combined with the upper liquid phase of step iv; vi) drawing said upper liquid phase of step iv, optionally combined with said filtrate of step v, to an anoxic reactor in which denitrification occurs under anoxic conditions; vii) drawing the content of the anoxic reactor to an aerobic reactor which is intensively aerated, whereby forming bacterial biomass and reducing dissolved organic matter; and viii) releasing said treated water, which contains lowered amounts of organic matter, solids, nitrogen, and phosphorus, to drain or collecting said treated water for reuse. Said step ii preferably comprises injecting an aqueous solution of PDAC to said collected wastewater, followed by injecting an aqueous solution of CPA to the mixture containing PDAC. The contents of organic matter in the collected wastewater of step i and treated water of step viii are characterized by chemical oxygen demand (COD) values of at most about 2200 mg/1 and typically about 650 mg/1, respectively. The process of the invention is particularly advantageously employed for waste water produced in pigs farms or in cows farms. In a preferred embodiment, the process of the invention is employed for treating wastewater produced in cattle industry or in dairy industry.

The process of the invention is an environmentally sensitive and economically effective process for treating wastewater produced during animal farming, including subsequent applications of two types of nitrogen containing cationic polymers whereby reducing the contaminants prevalent in animal farm wastewaters, reducing the high content of organic matter as reflected by COD, and reducing the high contents of solids.

### BRIEF DESCRIPTION OF THE DRAWING

The above and other characteristics and advantages of the invention will be more readily apparent through the following examples, and with reference to the appended drawing, wherein:

FIG. 1. is a scheme of a process according to one embodiment of the invention.

### DETAILED DESCRIPTION OF THE INVENTION

It was discovered by the instant inventor that it is very advantageous to treat the wastewater from animal farms with a coagulant like polydiallyldimethylammonium chloride (PDAC), followed by treating with a flocculant like cationic polyacrylamide (CPA). The two agents, sometimes employed in pulp industry, surprisingly turned out to remove much of the contaminants, including dissolved organic materials, from the wastewater produced in cattle and pigs farming, when the agents were employed in a specific order and specific concentrations.

In one embodiment of the invention, provided is a process for treating cattle or pigs farm wastewater, wherein the COD value of the treated water is lowered by 80-90%, wherein the dissolved organic material is substantially lowered by a mechanism of sweep flocculation, while removing about 50% nitrogen and about 70% phosphorus.

The treatment system according to the invention aims at bringing the parameters of wastewater from dairy farming, cattle farming, or other animal farming to the requested levels before releasing water to the sewage system, or close so that the parameters can be obtained with an augmentation of a small biological system. The wastewater may be created in many steps involved in the farming activities, including, for example, washing the objects, animals, spaces, etc., and it is rich in organic materials, mainly excrements and urine, straw residues, etc.

In one embodiment, the system according to the invention for treating farming wastewater comprises three elements: i) physico-chemical treatment resulting in settling most of the suspended solids and removing a large portion of the dissolved organic material, ii) a polishing biological system such as SBR resulting in removing additional contaminants, and iii) treatment of slurry and the sediments.

Provided is a water treatment kit for treating wastewater from livestock industry, comprising two aqueous solutions of nitrogen-containing cationic polymers, the former solution comprising a coagulant like polydiallyldimethylammonium chloride (known also as polyDADMAC), the latter a flocculant like cationic polyacrylamide, together with instructions for admixing the two materials into the treated water. Further, a method is provided for treating waste water with a high organic load, high chemical oxygen demand (COD) and biochemical oxygen demand (BOD) values, such as agricultural effluents from piggeries and cowsheds, by using coagulants and flocculants such as poly-DADMAC and cationic polyacrylamide. The technique, in one embodiment, employs several steps, comprising adding a coagulant agent to an aqueous process flow, allowing the coagulant agent to form aggregates, and then adding flocculating agent, so reducing the COD value by at least 40%. The subsequent combined application of PDAC and CPA was found to be very effective in treating the animal farm wastewater, and without wishing to be limited by any particular theory, the inventor believes that subsequently admixing two types of nitrogen-containing cationic polymers into the treated livestock industrial wastewater has a special positive effect on reducing the contaminants prevalent in animal farm wastewaters, which effect lasts throughout the whole cleaning process. The process usually comprises a pre-treatment step aiming at removing gross objects, for example employing bar screen.

### EXAMPLES

### Example 1

A wastewater sample from a cows farm was treated by employing two polymers, comprising adding polydiallyldimethylammonium chloride (PDAC) and cationic polyacrylamide (CPA) to a concentration of 300 ppm and 25 ppm, respectively, stirring, settling or filtering, and measuring the SS, COD and BOD. The order of addition of the two polymers was changed, as well as the stirring times, as shown in Table 1.

TABLE 1

| | | | | | COD | COD |
|---|---|---|---|---|---|---|
| | | Stirred | | Stirred | Before | After |
| No. | 1^{st} added | (sec) | 2^{nd} added | (sec) | (ppm) | (ppm) |
| 1 | PDAC | 60 | CPA | 30 | 15600 | 1350 |
| 2 | CPA | 60 | PDAC | 30 | 15600 | 7760 |
| 3 | CPA | 30 | PDAC | 60 | 15600 | 7220 |
| 4 | PDAC + CPA | 60 | | | 15600 | 6470 |

The results demonstrate that the best purification was obtained when the coagulant and the flocculant were added separately, wherein CPA was added subsequently after PDAC.

### Example 2

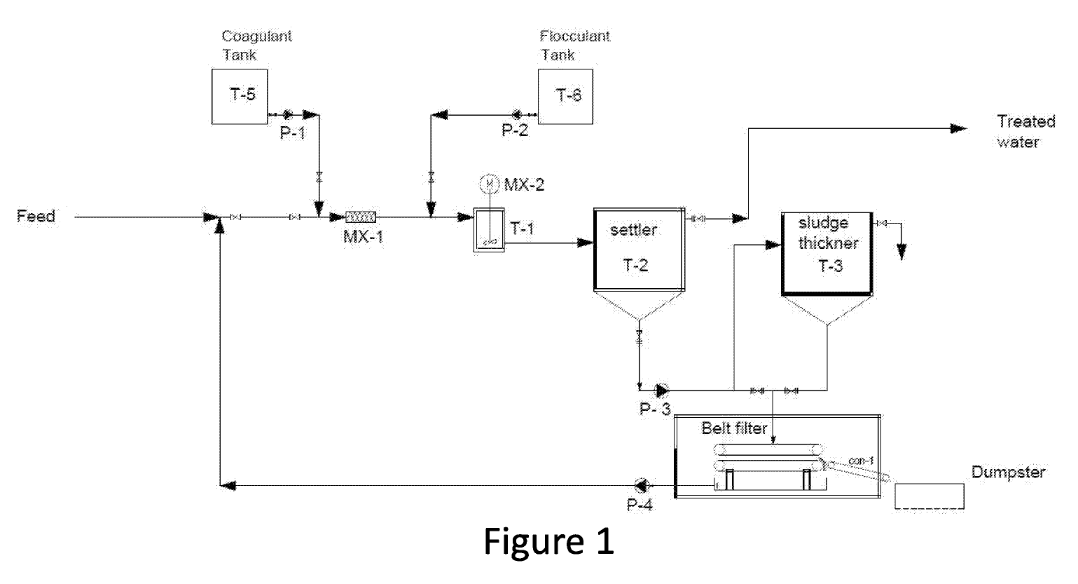

In one embodiment, the system aims at treating wastewater from dairy farm. Exemplified is treating wastewater in a farm of 300 cows producing about 25-30 m³ per day wastewater, mainly from dairy shed cleaning and yard wash-down. Typically, the system and the process according to the invention will comprise the elements similar to those described in the example, accompanied by FIG. 1.

### Physico-Chemical Treatment

### Adding Coagulant and Flocculant

The waste water flows from the collecting site (collecting pond or container) to the treating system by a flow rate of 1 to 1.2 m³/hr. The wastewater supply is usually constant from equalization tank. If water level in the equalization tank decreases under a certain predetermined level, the process stops. The stream from collecting site to the treating system may join with water stream recycled from the step of concentrating slurry, about 0.3 m³/hr filtrate. The stream of crude sewage (“Feed” in FIG. 1) flows from collecting site and is combined with the coagulant being diluted with water and pumped by dosing pump P-1 from coagulant tank T-5 (usually diluted with water 1:20). After injecting the coagulant to the line, the mixture flows through a fast static mixer (MX-1). The coagulant is adjusted to about 400 ppm. After injecting the coagulant and stirring the mixture, the flocculant, water diluted, is injected to the line by pump P-2 from tank T-6 (usually diluted with water 1:30) to a level of about 30 ppm. After injecting the coagulant to the line and mixing, and after injecting the flocculant to the line, the mixture flows to container T-1 in which it is stirred by stirrer MX-2, working at a velocity of about 100 rpm. The stirring time is about 2 minutes, depending on the container volume (about 20-30 liter).

### Settling

After intensive stirring in T-1, water flows to settler T-2 by gravity. The settled solids are separated from upper liquid phase. The solids move to the conic bottom, effecting the first concentration step of the formed sludge. The upper liquid moves to the system of biological treatment. Sludge is pumped, about 0.3 - 0.4 m³/hr, from the bottom of T-2 to sludge thickener T-3 and to a belt press filter, which increase the solid content in the sludge above 10%. The concentrated sludge is kept in a sludge container before taking away, and the filtrate is either returned to some of the previous stages or is transferred to the biological stage—according to the contaminants concentration.

### Biological Treatment

The water separated in the physico-chemical stage and transferred from the settler is pumped in a constant rate of 1 m³/hr to a small biological treatment (a part is returned to the physic-chemical process for dilutions).

The stage of biological treatment may be a batch process. Wastewater for the biological treatment is collected in a container having 20 m³, where a denitrification process runs—under anoxic conditions. The container is stirred under anaerobic conditions during which nitrogen is released. After the denitrification stage, taking about two and half hours the treated water flows to a container which works under aerobic conditions on the principles of Sequencing Batch Reactor (SBR), having 20 m³ and being aerated with 80 m³/hr air through efficient diffusers. The oxygen concentration is continually measured. The bacteria grow on the organic residues in the treated water and form a biomass. After reducing the organic matter in the treated water, the aeration is stopped, and the mixture is left without stirring to enable settling the biomass. A part of the biomass is drawn out for treating the sludge, most biomass remains to provide bacteria for the next round of biological treatment in the reactor. The upper part of treated water above the sediment, with reduced amount of organic matter, is drawn from the upper part of reactor, ready for releasing to drain or for reuse.

While this invention has been described in terms of some specific examples, many modifications and variations are possible. It is therefore understood that within the scope of the appended claims, the invention may be realized otherwise than as specifically described.

The terms “comprises”, “comprising”, “includes”, “including”, “having” and their conjugates mean “including but not limited to”. The term “consisting of” means “including and limited to”. As used herein, the singular form “a”, “an” and “the” include plural references unless the context clearly dictates otherwise. It is appreciated that certain features of the invention, which are, for clarity, described in the context of separate embodiments, may also be provided in combination in a single embodiment, and the above description is to be construed as if this combination were explicitly written. Conversely, various features of the invention, which are, for brevity, described in the context of a single embodiment, may also be provided separately or in any suitable subcombination or as suitable in any other described embodiment of the invention, and the above description is to be construed as if these separate embodiments were explicitly written. Certain features described in the context of various embodiments are not to be considered essential features of those embodiments, unless the embodiment is inoperative without those elements.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

1. A process for treating wastewater from livestock industry, comprising a step of subsequently admixing two different types of nitrogen-containing cationic polymers into the treated livestock industrial wastewater, wherein said polymers comprise polydiallyldimethylammonium chloride (PDAC) and cationic polyacrylamide (CPA).

2. The process of claim 1, wherein said PDAC is added to said wastewater up to a concentration of from 100 ppm to 1000 ppm, and said CPA is subsequently added to said wastewater up to a concentration of from 10 ppm to 50 ppm.

3. The process of claim 1, comprising steps of
i) collecting waste water from animal farming activities comprising high contents of organic matter, solids, nitrogen, and phosphorus;
ii) contacting said collected waste water with PDAC and stirring;
iii) subsequently contacting said collected waste water containing PDAC with CPA and stirring;
iv) allowing the mixture obtained in step iii) to stand without stirring, whereby separating an upper liquid phase with a reduced amount of solids and a lower phase with an increased amount of solids;
v) drawing said lower phase (dilute sludge) of step iv) to a belt press and filtering it, thereby obtaining a filtrate and a concentrated sludge having a solid content of 10% or more;
vi) drawing said upper liquid phase of step iv), optionally combined with said filtrate of step v), to an anoxic reactor in which denitrification occurs under anoxic conditions;
vii) drawing the content of the anoxic reactor to an aerobic reactor which is intensively aerated, whereby forming bacterial biomass and reducing dissolved organic matter; and
viii) releasing said treated water, which contains lowered amounts of organic matter, solids, nitrogen, and phosphorus, to drain or collecting said treated water for reuse.

4. The process of claims 3, wherein said step ii) comprises injecting an aqueous solution of PDAC to said collected wastewater, followed by injecting an aqueous solution of CPA to the mixture.

5. The process of claim 3, wherein the contents of organic matter in the collected wastewater of step i) and treated water of step viii) are characterized by chemical oxygen demand (COD) values of up to 2200 mg/1 and up to 650 mg/1, respectively.

6. The process of claim 1, wherein said wastewater is from a pigs farm.

7. The process of claim 1, wherein said wastewater is from a cows farm.

8. The process of claim 1, which is an environmentally sensitive and economically effective process for treating animal farm wastewater, including subsequent application of two types of nitrogen-containing polymers whereby reducing the contaminants prevalent in animal farm wastewaters, including reducing the high phosphorus and nitrogen contents, reducing the high content of organic matter as reflected by COD, and reducing the high contents of solids.
